(19) United States
(12) Patent Application Publication
(10) Pub. No.: US 2018/0374040 A1
(43) Pub. Date: Dec. 27, 2018

(54) SYSTEM AND METHOD FOR COMMUNICATION BETWEEN SUPPLIERS/SERVICE, TRUCKING AND END USERS

(71) Applicant: Callout, Inc., St. Louis, MO (US)

(72) Inventor: David R. Hunt, St. Louis, MO (US)

(21) Appl. No.: 16/020,506

(22) Filed: Jun. 27, 2018

Related U.S. Application Data
(60) Provisional application No. 62/525,326, filed on Jun. 27, 2017.

(51) Int. Cl. G06Q 10/08; H04W 4/08

(52) U.S. Cl. CPC G06Q 10/0833; H04W 4/08; G06Q 10/0835

(57) ABSTRACT

Systems and methods for facilitating communications between users in a supply chain are disclosed. In one implementation, a method includes receiving, from a user device of an end user, a request to create a shipment project. The request may include shipment data received from the end user. The method may further include creating, in the databases, the project based on the request, notifying a user device associated with a supplier that the supplier has been invited to the project, and receiving, from the user device associated with the supplier, an indication that the supplier approved the invitation. Furthermore, the method includes, after receiving the indication, adding the supplier to the project and receiving requests to invite additional users to the project. The additional users may include at least a trucking dispatch and a driver. Moreover, the method includes notifying user devices associated with the additional users of their invitations, facilitating real-time communications among users associated with the project, and providing shipment updates associated with the project to at least one user device.

### RELATED APPLICATIONS

The present application claims priority to U.S. Provisional Application No. 62/525,326, which is incorporated by reference herein for all purposes.

### TECHNICAL FIELD

The present disclosure pertains to systems and methods for facilitating communications between users in a supply chain. In particular, the present disclosure pertains to systems and methods for facilitating communications between an end user, a supplier, a trucking dispatch, and/or truck drivers involved in a shipment project.

### BACKGROUND

The oil and gas business is a multifaceted, global industry that impacts all aspects of our lives, including providing the world's 7 billion people with 60 percent of their daily energy needs. Oil and gas represent global commerce on a massive scale. World energy markets are continually expanding, and companies spend billions of dollars annually to maintain and increase their oil and gas production.

In the United States, the oil and gas industry represents a $130 billion-dollar industry. The U.S. oil & gas industry is made of up thousands of companies engaged in upstream, midstream, and downstream. Oil & Gas supports over 9 million jobs in the U.S. In 2016, an independent study by Rystad Energy stated the US had the largest oil reserves in the world.

The oil and gas business is often referred to a boom or bust industry. In November 2014, the price of oil began to decline. The falling price of oil is causing massive changes within the oil and gas supply chain. A current glut of oil supply, in combination with slowing demand, has led to rapidly declining production in the U.S., which has been particularly harmful for upstream drilling and exploration companies. There are many factors that have contributed to falling oil prices, and the entire supply chain is affected in one way or another, but very high supply and weak demand have been main factors in driving down the price of oil.

Low oil prices, growing supply inventories and decreasing global demand have created new challenges in the oil and gas (O&G) industry. Historically, O&G companies' soaring profits masked the poor state of logistics operations within their supply chains. Now that profits are thin; oil and gas companies are rushing to save money wherever they can. O&G companies realize the savings potential in their disordered logistics processes, specifically in transportation management.

### SUMMARY

Systems and methods for facilitating communications between users in a supply chain are disclosed. In one embodiment, a method includes receiving, from a user device of an end user, a request to create a shipment project. The request may include shipment data received from the end user. The method may further include creating, in the databases, the project based on the request, notifying a user device associated with a supplier that the supplier has been invited to the project, and receiving, from the user device associated with the supplier, an indication that the supplier approved the invitation. Furthermore, the method includes, after receiving the indication, adding the supplier to the project and receiving requests to invite additional users to the project. The additional users may include at least a trucking dispatch and a driver. Moreover, the method includes notifying user devices associated with the additional users of their invitations, facilitating real-time communications among users associated with the project, and providing shipment updates associated with the project to at least one user device.

In another embodiment, a method includes receiving, from a user device of a supplier, a request to create a project. The request may include shipment data received from the supplier. The method may further include creating, in the databases, the project based on the request, notifying a user device associated with an end user that the end user has been invited to the project, notifying a user device associated with a trucking dispatch that the trucking dispatch has been invited to the project, receiving, from the user devices associated with the end user and the trucking dispatch, indications that the invitations have been approved, adding the end user and the trucking dispatch to the project, and receiving requests to invite additional users to the project, wherein the additional users include at least a driver. The method further includes notifying user devices associated with the additional users of their invitations, facilitating real-time communications among users associated with the project, and providing shipment updates associated with the project to the users associated with the project.

In yet another embodiment, a system includes one or more servers communicatively connected via a network to one or more user devices; and one or more databases communicatively connected to the servers. The user devices are associated with at least an end user, a supplier, a trucking dispatch, and a driver associated with the trucking dispatch. The servers are configured for receiving, from a user device of the supplier, a request to create a project. The request may include shipment data received from the supplier. The servers are further configured for creating, in the databases, the project based on the request, notifying a user device associated with the end user that the end user has been invited to the project, notifying a user device associated with the trucking dispatch that the trucking dispatch has been invited to the project, receiving, from the user devices associated with the end user and the trucking dispatch, indications that the invitations have been approved, adding the end user and the trucking dispatch to the project, and receiving requests to invite additional users to the project. The additional users include at least the driver. The servers are further configured for notifying user devices associated with the additional users of their invitations, facilitating real-time communications among users associated with the project; and providing shipment updates associated with the project to the users associated with the project.

In another embodiment, a system includes one or more servers communicatively connected via a network to one or more user devices, and one or more databases communicatively connected to the servers. The user devices are associated with at least an end user, a supplier, a trucking dispatch, and a driver associated with the trucking dispatch. The servers are configured for receiving, from a user device of the end user, a request to create a shipment project. The request may include shipment data received from the end user. The system further includes creating, in the databases, the project based on the request, notifying a user device associated with the supplier that the supplier has been invited to the project, receiving, from the user device associated with the supplier, an indication that the supplier approved the invitation, and after receiving the indication, adding the supplier to the project. The servers are further configured for receiving requests to invite additional users to the project. The additional users include at least the trucking dispatch and the driver. Moreover, the servers are further configured for notifying user devices associated with the additional users of their invitations, facilitating real-time communications among users associated with the project, and providing shipment updates associated with the project to at least one user device.

### BRIEF DESCRIPTION OF THE DRAWINGS

FIG. 1 illustrates a system for facilitating communications between users in a supply chain in accordance with the disclosed embodiments.

FIG. 2 illustrates a login screen allowing a user to begin a Callout, activate a Callout, view reports and log-in to the network in accordance with the disclosed embodiments.

FIG. 3 illustrates a desktop computing device having a login screen in accordance with the disclosed embodiments.

FIG. 4 illustrates a default screen that combines logistics/CRM/project management/billing software platform in accordance with the disclosed embodiments.

FIG. 5 illustrates a default screen once a CallOut is selected in a menu bar in accordance with the disclosed embodiments.

FIG. 6 illustrates a default screen for creating of a callout by suppliers in accordance with the disclosed embodiments.

FIG. 7 illustrates a default screen for creating of a callout by end users in accordance with the disclosed embodiments.

FIG. 8 illustrates a default Contacts Dashboard screen after Contacts is selected in accordance with the disclosed embodiments.

FIG. 9 illustrates a default Billing Dashboard screen after Billing is selected from the menu bar in accordance with the disclosed embodiments.

FIG. 10 illustrates a default Truck Driver Dashboard screen in accordance with the disclosed embodiments.

FIG. 11 illustrates a process for creating a callout by a supplier in accordance with the disclosed embodiments.

FIG. 12 illustrates a process for creating a callout by an end user in accordance with the disclosed embodiments.

FIGS. 13-21 illustrates alternative defaults screens in accordance with the disclosed embodiments.

### DETAILED DESCRIPTION

In the following description, for the purposes of explanation, numerous specific details are set forth in order to provide a thorough understanding of embodiments of the present technology. It will be apparent, however, to one skilled in the art that embodiments of the present technology may be practiced without some of these specific details. While, for convenience, some embodiments of the present technology are described with reference to the multi-component data object in isolation, embodiments of the present technology create system that can be used in any context to help users consolidate information and coordinate interactions and/or events. In addition, embodiments are equally applicable to various other infrastructures within computer systems.

Moreover, the techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, but is not limited to, floppy diskettes, optical discs, compact disc read-only memories (CD-ROMs), magneto-optical discs, ROMs, random access memories (RAMs), erasable programmable read-only memories (EPROMs), electrically erasable programmable read-only memories (EEPROMs), application-specific integrated circuits (ASICs), magnetic or optical cards, flash memory, or other type of media/machine-readable medium suitable for storing electronic instructions.

### Terminology

Brief definitions of terms, abbreviations, and phrases used throughout this application are given below.

The term “oil and gas industry supplies” herein refers to raw material and equipment used by end users in the oil and gas industry including but not limited to pipe, chemicals, drilling equipment, sand, etc.

The term “supplier” generally refers to an entity that supplies oil and gas industry supplies and other materials to the oil and gas industry.

The term “end user” herein generally refers to an entity that operates drilling rigs, builds wells and/or installs pipeline in the oil and gas industry.

The term “trucking” generally refers to an entity that transports oil and gas industry supplies from a supplier to an end user.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

The term “module” or “engine” refers broadly to general or specific-purpose hardware, software, or firmware (or any combination thereof) components. Modules and engines are typically functional components that can generate useful data or other output using specified input(s). A module or engine may or may not be self-contained. Depending upon implementation-specific or other considerations, the modules or engines may be centralized or functionally distributed. An application program (also called an “application”) may include one or more modules and/or engines, or a module and/or engine can include one or more application programs.

As used herein, a “callout” refers to a shipment project for coordinating the delivery of goods (e.g., from an origin to a destination utilizing multiple trucks). In an embodiment, a callout includes shipping constraints based on time, volume of product, type of vehicle, and/or the nature of the product being transported. For example, a callout may require usage of certain container trucks and/or trucks having certain transport capacity. In another example, a callout may require shipping trucks adhering to or meeting certain product licensure and/or container characteristics.

### Overview

The supply chain of the oil and gas (O&G) industry is complex. Suppliers of pipe, chemicals, drilling equipment, sand and other materials must move products efficiently to and from drilling sites, upstream, locations and compressor locations. O&G transportation often involves servicing remote locations with no infrastructure, which slows down operations and contains substantial safety and financial risk.

Shipping disruptions result in a significant financial loss for the companies involved. Not only is financial loss and issue, but time wasted and loss of productivity are also significant problems because there is not a centralized means for all parties involved in the process to effectively communicate along each point of the process.

Communication between the supply chain, logistical companies, and end users is incomplete and fragmented. There is currently no technology being used that allows all parties involved in the distribution of O&G to communicate to each other, together in unison. With a supply chain that is as complex as that in the oil and gas industry, unified communication is paramount to expedite changes caused by the fluctuations within this process.

Since there is currently no avenue for suppliers to communicate with the entire supply chain, suppliers are currently experiencing communication problems. For example, when a truck does not arrive on schedule, which happens often, approximately 6 phone calls (at minimum) will take place. First, the end-user calls the supply company. The supply company must then call the trucking company dispatch. The trucking company must then locate and call each driver because projects often require multiple trucks, from different carriers. Subsequently, the trucker responds to dispatch, and the dispatch responds to the supplier. Finally, the supplier responds to the end user. To make matters worse, since O&G is sourced 24/7/365, issues most often occur not during “normal” business hours, and requires a disruption in evenings, weekends, & holidays for the supplier. Late deliveries of supplies damage the relationships with end users. Further, inaccurate info is given from the truck driver that cannot be verified and is often proven wrong. This causes high operating costs for equipment and services needed to offload trucks and frustrated end users. This often also triggers more phone calls.

Trucking Companies in the Oil and Gas Industry represent a significant piece of the oilfield. A recent study by PLS logistics shows that a single drilling rig on an 8-well pad will utilize the services of between 5,800 to 8,900 trucks before it moves to the next site. As of January 2017, Baker Hughes shows 712 active drilling rigs running in the U.S. Constant efficiencies within the industry is allowing these rigs to drill more wells every year which will increase the demand on trucking companies and suppliers as such.

Since there is currently no avenue for logistical companies to communicate with the entire supply chain, logistical companies are currently experiencing several problems. First, there is a lack of communication by truck drivers when delays occur in transport due to traffic, mechanical issues, accidents, weather, etc. Second, “trigger” phone calls may be issued. For example, when a truck does not arrive on schedule, which happens often, approximately 6 phone calls (at minimum) will take place. The end user calls the supply company. The supply company must then call the trucking company dispatch. The trucking company must then locate and call each driver because projects often require multiple trucks, from different carriers. The trucker responds to dispatch, and the dispatch responds to the supplier. Finally, the supplier responds to the end user. To make matters worse, since O&G is sourced 24/7/365, issues most often occur not during “normal” business hours, and require a disruption in evenings, weekends, & holidays for the supplier.

### Truck Driver Problems

Since there is currently no avenue for truck drivers to communicate with the entire supply chain, truck drivers are currently experiencing the following problems: (1) Inconvenience of communicating to dispatch or suppliers when delays occur in transport due to traffic, mechanical issues, accidents, weather, etc. (2) Inability to plan for route adjustments, due to changes in delivery location or bond roads. (3) Language barriers cause confusion between drivers & supply chain. (4) Frustration when end user delivery location is difficult to find. (5) Dispatch may not be available nights/weekends/holidays, leaving the truck driver on his own.

### End User Problems

Since there is currently no avenue for the end user to communicate with the entire supply chain, end users are currently experiencing the following problems: (1) Deliveries that are late can cost the operator or supplier up to $300/hour to wait if proper communication does not take place in advance. (2) Deliveries that would halt the operation of a horizontal drilling rig could cost as much as $1500/hr. in standby time. (3) Wasted time. (4) Time consuming adjustments for delivery times as rigs speed up and slow down which may require deliveries to be expedited. Furthermore, trigger phone calls may be issued. For example, when a truck does not arrive on schedule, which happens often, approximately 6 phone calls (at minimum) will take place. First, the end user calls the supply company. The supply company must then call the trucking company dispatch. The trucking company must then locate and call each driver because projects often require multiple trucks, from different carriers. The trucker responds to dispatch, and the dispatch responds to the supplier. Finally, the supplier responds to the end user. To make matters worse, since O&G is sourced 24/7/365, issues most often occur not during “normal” business hours, and require a disruption in evenings, weekends, & holidays for the supplier.

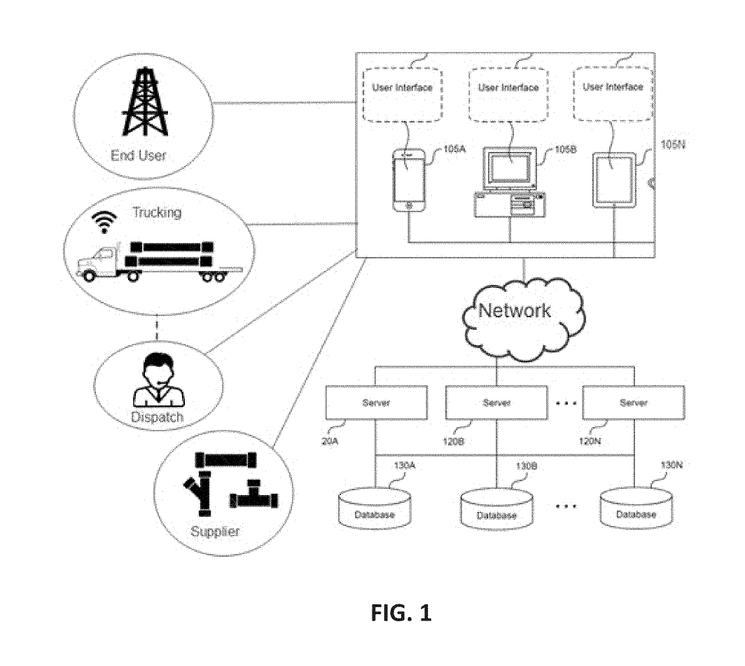

FIG. 1 illustrates an example of a networked-based environment 100 in which some embodiments of the present technology may be utilized.

The embodiments illustrated in FIG. 1 show a network in which suppliers, end users, trucking and dispatch can communicate to efficiently coordinate and track delivery of supplies from suppliers to end users. For example, the disclosed systems connect the entire supply chain under one system, including exploration and production (E&P)/midstream companies, service/supply companies, trucking/3 pl companies, truck drivers, storage yards. Companies as well as individuals may be added to the disclosed system, and all parties in the disclosed system may communicate directly to another party or parties.

Examples of a user on computing devices 105A-105N include, but are not limited to, a user on his or her mobile device or personal computer, a user on his or her mobile device or personal computer using a mobile application or software program, and the like. Computing devices 105A-105N can execute a browser application or a customized client to enable interaction, using network 115, between the computing devices 105A-105N and one or more servers 120A-120N for handling server responses. Computing devices 105A-105N may include user interfaces 110A-110N.

Computing devices 105A-105N may be configured to use network 115 to communicate with one or more servers 120A-120N. In addition or alternatively, the computing devices 105A-105N may be configured to use a peer-to-peer network. In addition or alternatively, computing devices 105A-105N may be configured to perform some functions while offline without network access and acting as stand-alone devices.

In accordance with various embodiments, network 115 can include any combination of local area and/or wide area networks, using both wired and wireless communication systems. In one embodiment, network 115 uses standard communications technologies and/or protocols. Thus, network 115 may include links using technologies such as Ethernet, 802.11, worldwide interoperability for microwave access (WiMAX), 3G, 4G, LTE, CDMA, digital subscriber line (DSL), and/or short range and PAN and WPAN network technologies, including but not limited to USB, FireWire, Bluetooth, NFC, INSTEON, IrDA, Wireless, USB, Bluetooth, Z-Wave, ZigBee, Body Area Network, satellite communication networks, global positioning systems and private low earth orbit satellite networks.

Similarly, the networking protocols used on network 115 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over network 115 may be represented using technologies and/or formats including hypertext markup language (HTML), extensible markup language (XML), JSON, or MongoDB object (BSON) formats. In addition, all or some links can be encrypted using conventional encryption technologies such as secure sockets layer (SSL), transport layer security (TLS), and Internet Protocol security (IPsec).

In some embodiments, computing devices 105A-105N can retrieve or submit information to one or more servers 120A-120N. In some examples, the servers 120A-120N may be configured as a server cluster. Servers 120A-120N can reply to the computing devices 105A-105N with several responses, including multi-component data object information. Servers 120A-120N can connect to one or more databases 130A-130N. In some examples, the databases 130A-130N may be configured as a database cluster. Databases 130A-130N can store a variety of information including information the user is interested in accessing such as customer information, pricing, billing information, contracts, callout history, etc. While FIG. 1 illustrates servers 120A-120N in a centralized structure, other embodiments can include a cloud configuration and/or a peer-to-peer network and storage system.

In accordance with various embodiments, computing devices 105A-105N may request data components of a multi-component data object stored on one or more of the databases 130A-130N or one or more of the servers 120A-120N. The user interfaces 110A-110N may display information associated with the multi-component data object, and allow users to interact with servers 120A-120N.

In accordance with some embodiments, servers 120A-120N may provide a variety of data access to computing devices 105A-105N. Examples of data access can include user profile information, user time and positioning information, and other types of information described herein. For example, one or more databases 130A-130N can include information such user identity information, supply pricing information, etc.

In some embodiments, the computing devices 105A-105N may solicit one or more servers 120A-120N to establish a text, telephony, VOIP, audio, and/or video-based, asynchronous or synchronous (live) communication channel with another user, either with no specific context, or with a context based on one or several multi-component data objects. In some embodiments, the computing devices 105A-105N may solicit from one or more servers 120A-120N a list of multi-component objects that are related to the multi-component object that the user is currently interacting with on the computing device 105A-105N.

In some embodiments, one or more servers 120A-120N are used to monitor accounts and information stored in databases 130A-130N. Servers 120A-120N can include various data processing and analytic tools that allow for implementation, creation, updating, deletion, and communication of a multi-component data object. In some embodiments, servers 120A-120N are used to store the individual components of a multi-component data object, and transmit the components to one or more computing devices 105A-105N. In addition, servers 120A-120N may access one or more databases 130A-130N having stored thereon the components of a multi-component data object.

In some embodiments, computing devices 105A-105N request information associated with the components of a multi-component data object from the user and from one or more servers 120. The computing devices 105A-105N may then generate the multi-component data object and communicate the multi-component data object to the servers 120A-120N.

Servers 120A-120N may be implemented in distributed computing environments, where tasks or modules are performed by remote processing devices, which are linked through network 115. In a distributed computing environment, program modules or subroutines may be located in both local and remote memory storage devices. Distributed computing may be employed to load balance and/or aggregate resources for processing.

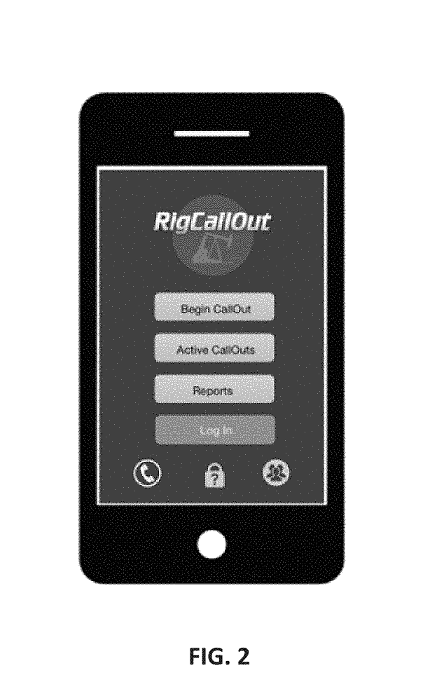

In one embodiment, computing devices 105A-105N is a mobile device having a login screen allowing a user to begin a Callout, activate a Callout, view reports and log-in to the network, for example substantially as shown in FIG. 2. In one embodiment, the mobile login screen has one or more of the following features: (1) Fingerprint sign-in availability or password login; (2) iPhone/Android compatible (e.g., iOS/Android App or via a desktop browser (e.g., Progressive Web Apps PWA)); (3) Login Protocol: After 3 attempts/2 Hint attempts/forgot email pass reset is automatically generated; (4) CallOut Support Call Feature; and/or (5) Callout Support Chat Feature.

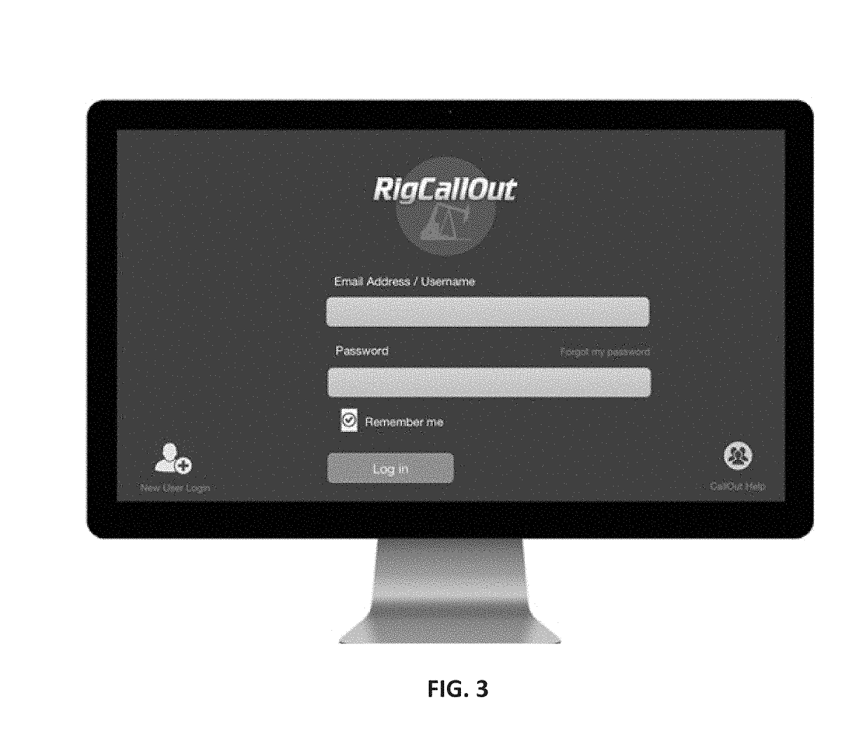

In one embodiment, computing devices 105A-105N is a desktop computing device having a login screen substantially as shown in FIG. 3. In one embodiment, desktop login features include one or more of: (1) “Remember me” capability; (2) Logo links to RigCallOut website; (3) New User Login (Sign In link triggers New User Protocol); and a (4) Screen popup that gives an option to create a new user in established company or an option to create a new user in CallOut. If the user selects to create a new user in CallOut, the user is directed to CallOut Support Center via chat to set-up account & payment terms. In the screen of FIG. 3, CallOut Help & support chat feature is highlighted. After 3 attempts or 2 Hint attempts, forgot email pass reset is automatically generated. Forgot my password Protocol offers an option for providing a password hint or an option to reset the password.

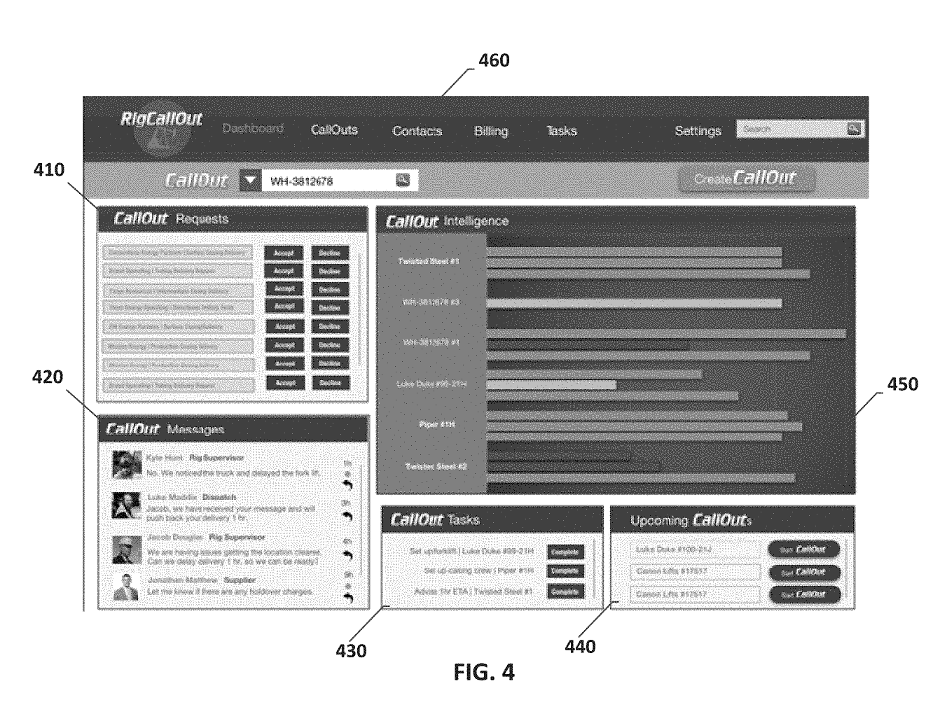

In one embodiment, the system comprises a default screen after login providing information for suppliers, trucking, dispatch and/or end users. For example, FIG. 4 shows an example default screen that combines Logistics/CRM/Project Management/Billing Software Platforms. As shown in FIG. 4, categories 460 include: CallOuts, Contacts, Billing, & Tasks. Here, users can connect to each other through “CallOuts” with unique codes designating permissions and projects. CallOut designates unique codes for users. The interface includes connectivity to all parties in CallOuts, including trucks & drivers. In particular, drivers can communicate into the disclosed systems and the disclosed systems can communicate with the drivers. The system may include a Responsive Route Map (not shown in FIG. 4) via generated using CallOut Intelligence. Further, the image capture feature (not shown in FIG. 4) provides up-to-the-minute images of delivery tickets, bills of lading, invoices, check verification collected on location (COD). A user may login and manage the system via a desktop computer or a smartphone. Trigger communications are provided by text messages, dial feature, and/or email.

As shown in FIG. 4, the dashboard includes a CallOut Intelligence section 450. This section shows the pace of each truck and its specified delivery time. Green signifies on time. Yellow signifies a potential delay. Red indicates the truck is delayed. Suppliers, Trucking Dispatch, & End Users can customize their delivery window timeline in settings, otherwise the default CallOut delivery window timeline is used. For example, default timeline for green is +30 min from delivery time, default timeline for yellow is 31-120 min from delivery time, and default timeline for red+2 hours from delivery time. Delivery time icon shows the delivery time when user hovers over it.

The dashboard also includes a CallOut Requests section 410 listing callout invitations that have not been responded to. (Users can request others to join a CallOut.) Each User can pick in the settings if they also want to be notified via email and/or text when a new CallOut request is added. Each User can create a customized plan for CallOut Requests that have not been responded to in settings, otherwise a default CallOut Request Protocol is used. Default for Supplier & Trucking Dispatch: pop-up is initiated upon log-in, which recaps new CallOuts that haven't been responded to and their direct links at +2 hours. Automatic text/email is also sent to user. Default for Supplier & Trucking Dispatch may be that an Administrator is notified via text, email, and/or dashboard popup at +6 hours no response. Default for End User may be that a pop-up is initiated upon log-in, which recaps new CallOuts that haven't been responded to and their direct links at +6 hours. Automatic text/email is also sent to user. Default for End User may be that an administrator is notified via text, email, and/or dashboard popup at +24 hours no response.

The dashboard further includes a CallOut Messages 420 section. This section enables real time messaging for all active users. However, an active CallOut does not need to be created in order to use the messaging feature because a user can create a message through an active CallOut and it will allow for the message to be associated with a specific project.

CallOut Tasks section 430 displays tasks to be completed during the callout process. Tasks are set-up by each individual user. A task can be created by another user at the same company and will also show up on the task dashboard.

Upcoming CallOuts section 440 enables a user to set up CallOuts ahead of time for efficiency and last-minute CallOuts.

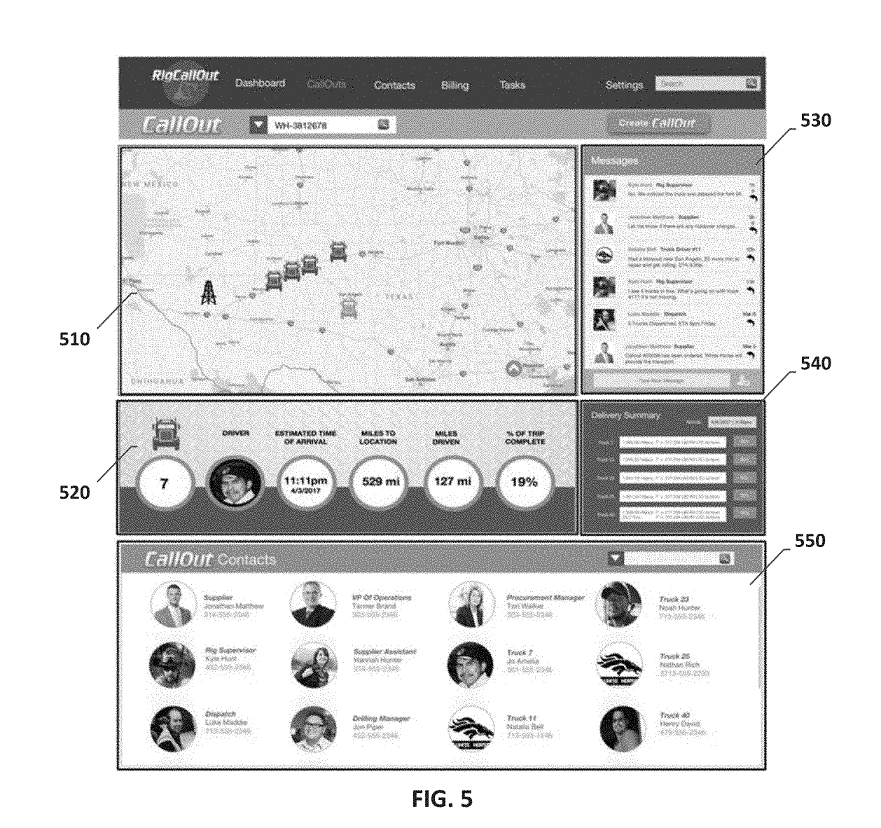

In one embodiment, the system provides a default screen once a CallOut is selected in the menu bar, for example as shown in FIG. 5. The screen in FIG. 5 include a CallOut Map 510 with CallOut Intelligence. The map displays shipping point and rig destination and shows individual trucks that make up the CallOut en-route. CallOut Intelligence color codes each truck based upon the pace of each truck in conjunction with its specified delivery time. Suppliers, Trucking Dispatch, & End Users can customize their delivery window timeline in settings, otherwise the default CallOut delivery window timeline is used. This setting affects both the CallOut Dashboard & Main Dashboard. For example, default timeline for green is +30 min from delivery time, default timeline for yellow is 31-120 min from delivery time, and default timeline for red+2 hours from delivery time. A user can click on the truck to show specific truck/user details below the map in section 520. Truck details may include, for example, descriptions of what is on or within a particular truck and/or load-specific documents (e.g., documents for complying with a regulation or licensure). In some embodiments, the map may be generated based on a particular project(s). Alternatively, the map may be generated based on all data available to the system. In some embodiments, the map may show trucks associated with a particular callout and/or shipment. Alternatively, or additionally, the map may show trucks that are part of a particular fleet(s), company, or system.

The screen in FIG. 5 also shows a Messaging section 530 that shows real-time messaging between users on the Callout. The screen also lists in the Contacts section 550 details of all users that have been invited into a CallOut and their contact information. Orange link to phone, email, and/or text if clicked on. There are an unlimited number of users that can be added to a CallOut. A user can place call to a user with once by click on a name.

FIG. 5 also shows a Delivery Summary section 540 that shows what each truck shipment contains. Here, a user may have access to a PDF copy of Bill of Lading (BOL). (Signed copies of BOL can be uploaded from location via smartphone camera from any user.)

In some embodiments, the dashboard may facilitate document sharing. Documents such as Proof Of Delivery, Bill Of Lading, Mill Test Report's, pictures, tallies may be uploaded and shared among users of the callout.

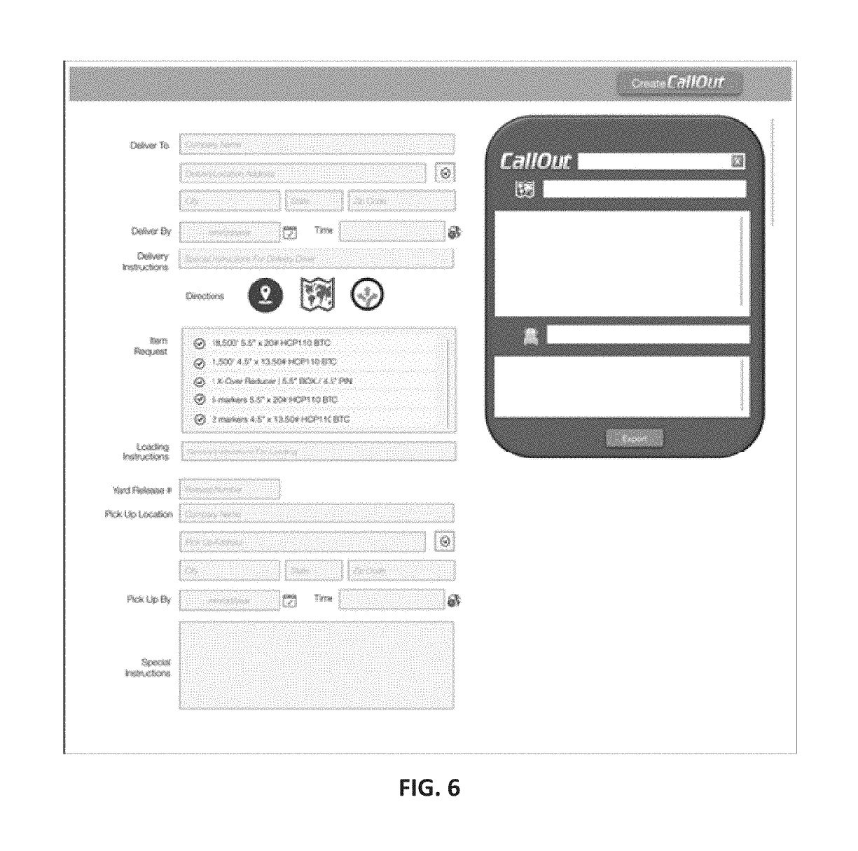

In one embodiment, the system provides a default screen for creating of a callout from suppliers, for example as shown in FIG. 6. In some embodiments, the delivery address may be prefilled (e.g., based on previous callouts).

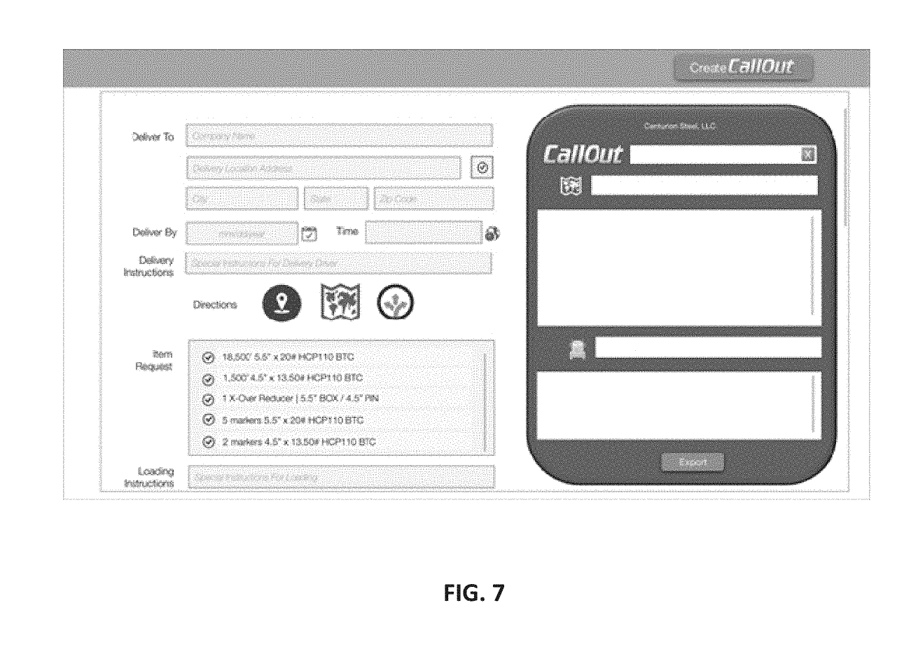

In one embodiment, the system provides a default screen for creating of a callout from end users, for example substantially as shown in FIG. 7. In some embodiments, the delivery address may be prefilled (e.g., based on previous callouts). In one embodiment, the system provides a default screen for creating of a callout from end users including one or more of the following features. (1) Purchase Order Creation: This feature auto populates trucking sheet on the right side of screen. Users can Export the trucking sheet. (2) When Users click Export it will generate a popup that gives user options while exporting including: Print, Bill. (3) Item requests are pre-loaded into user platform during onboarding process and items can be added by admin. Destination can be added with mapping “Pin Drop” feature while on location. Mapping will give directions via google maps or smartphone mapping features.

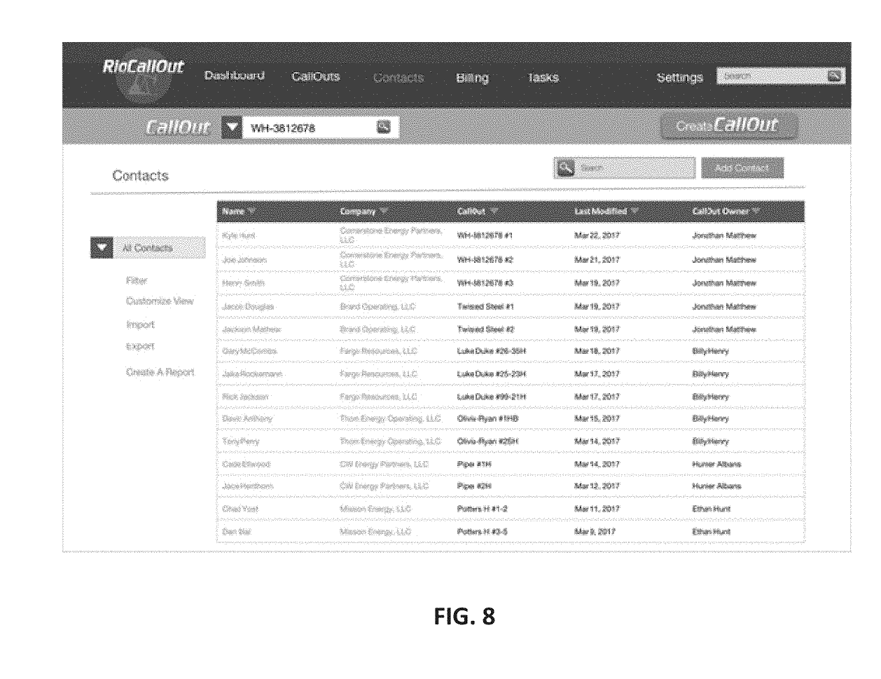

In one embodiment, the system includes a default Contacts Dashboard screen after Contacts is selected, substantially as shown in FIG. 8. In one embodiment, the Contacts Dashboard features: Sorting Columns and/or Orange hyperlinks connect Users to User & Company Profiles.

As shown in FIGS. 4-8, the disclosed systems enable a supplier or an end-user to create a callout (i.e., a shipment project) that can be used to coordinate a delivery that requires coordination of multiple individuals and organizations (e.g., supplier, trucking dispatch, truck drivers). For example, an end-user or a supplier may create a callout using the screens shown in FIG. 6 or FIG. 7. As shown in these figures, the end user or the supplier may create a callout by providing, for example, items requested, delivery destinations, pick up locations, pick up constraints (e.g., pick up date/time), delivery/loading instructions, and delivery constraints (e.g., delivery date/time). After a callout is created, invitations are sent to a supplier and a trucking dispatch (if the callout is created by an end user) or to an end-user and a trucking dispatch (if the callout is created by a supplier). The invitation is displayed on the end user or the supplier's dashboard shown in the CallOut Requests section in FIG. 4. The end user or the supplier may accept or decline the callout via the dashboard in FIG. 4. Once the invitation is accepted, the user becomes a part of the callout. A user of the callout may invite additional users to the callout (e.g., a trucking dispatch may invite truck drivers that will be involved in the delivery).

Once a user becomes a part of a callout (e.g., end user, supplier, truck driver, trucking dispatch), the user may access a callout-specific dashboard (e.g., as shown in FIG. 5) that shows information pertaining to the delivery associated with the particular callout. For example, the dashboard may show status/details of trucks that are involved in the delivery (e.g. current location, estimated time of arrival, driver information, etc.), messages to/from users associated with the callout (e.g., truck drivers, dispatch, supplier, end-user), contact information of individuals/organizations associated with the delivery, and documents (e.g., POD, BOL) associated with the delivery.

Accordingly, using these interfaces, various individuals/organizations involved in a callout may coordinate various aspects of a delivery to minimize, for example, cost and/or delivery time. For example, a supplier and/or an end-user may use these interfaces to directly communicate with the truck drivers and ensure that the trucks arrive at staggered consecutive times throughout the day to minimize the time a truck is waiting for another truck to finish unloading.

Furthermore, the disclosed system enables any driver with an access to a smart phone to be tracked (e.g., non-company or asset-based trucks, subcontracted drivers/trucks).

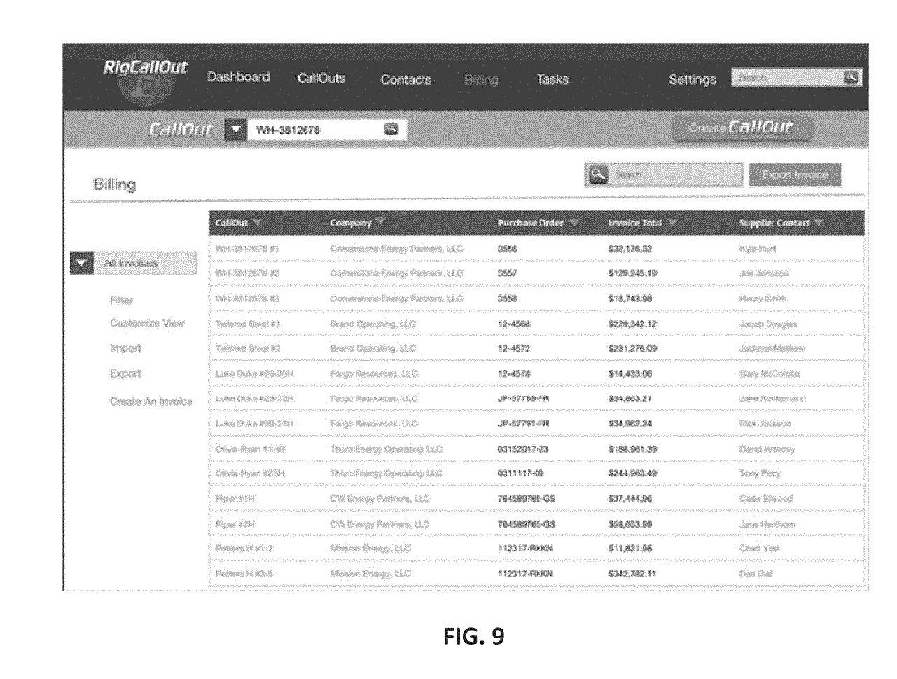

In one embodiment, the system includes a default Billing Dashboard screen after Billing is selected from the menu bar, substantially as shown in FIG. 9.

In various embodiments, the Billing Dashboard comprises one or more of the following features: Sorting Columns and/or CRM/Invoicing features that allow a supplier to quickly generate CallOut and automatically generate invoices that can be uploaded from the platform. (ADP/Open Invoice connectivity).

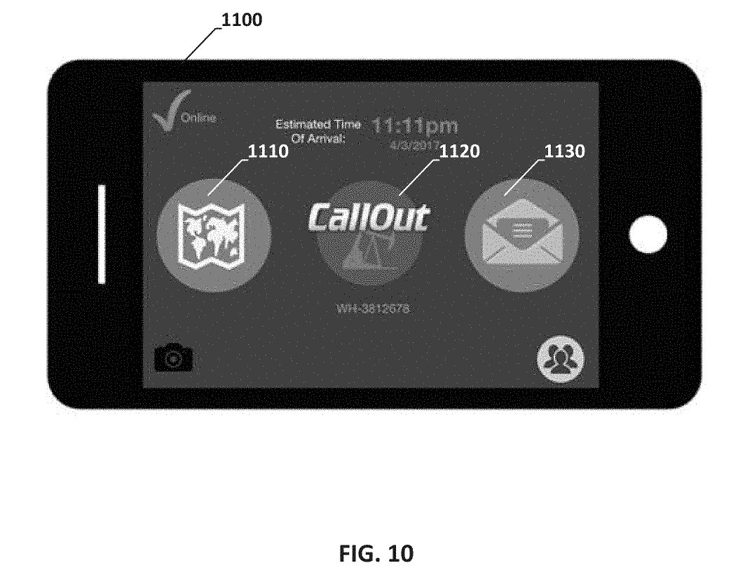

In one embodiment, the system includes a default Truck Driver Dashboard screen, for example substantially as shown in FIG. 10. In some embodiments, the Truck Driver Dashboard includes one or more of the following features. (1) the dashboard 1100 is universal dash mount & smart phone sourced. (2) Drivers Login & Start CallOut 1120: Default feature added to gather data even if Start CallOut is not selected, and Dispatch can also start CallOut by selecting user & start CallOut. (3) Responsive Route Map 1110: User clicks on map icon and can view the responsive CallOut Intelligence Map from the CallOut Dashboard. All trucks part of the CallOut fleet are visible.

The driver app may provide turn-by-turn directions of lease roads. Energy companies often build roads (i.e., “lease roads)” to their drill site location. Google directions/Apple maps do not have data pertaining to these roads.

Estimated time of arrival is displayed at the top with CallOut Intelligence color coding based upon the pace compared to the time of arrival.

CallOut may utilize a messaging feature 1130 to provide information between the parties regarding delivery conditions, truck mechanical issues, and logistics delays. If the truck is stopped, the messaging icon will flash when a new message has been added. While in motion, message alerts will be communicated via VOICE communication only. Upon stopping all messages will be displayed in text within the messaging feature.

Due to the remote locations of the energy industry, CallOut may utilize satellites to capture GPS data from the truck and uploads to the CallOut mobile application platform to provide critical data (e.g., speed and location of the truck) to the end user. Alternativley, the system may transmit location using Cell Towers (mobile cell service), Satellite (low-Earth orbit satellites), Wi-Fi & cell tower triangulation systems. The information may be collected & transmitted via a smart device application.

In some embodiments, the driver app may be capable of creating a fully digital proof of delivery ticket with a signature box allowing the receiver of goods and services to sign the device in a digital format. This will have fields with all applicable shipping/receiving/invoicing requirements in a digital format.

In some embodiments, the disclosed system may notify individuals or organizations associated with a pickup location when one or more trucks will arrive at the pickup location and what the trucks are required to pick up. For example, using the disclosed systems, yards may track trucks to the yard so the yards may better allocate resources and load the trucks faster. (A copy of the trucking sheet may be provided via the disclosed system to inform them on what will be shipped on the truck and how to load items.)

In some embodiments, the disclosed system may enable a truck or a truck driver to be switched in a call out. For example, in a situation where the system is tracking a specific driver and the truck is permanently disabled, the system may be configured to begin tracking a new/replacement truck driver.

All interfaces may be presented in both English and Spanish.

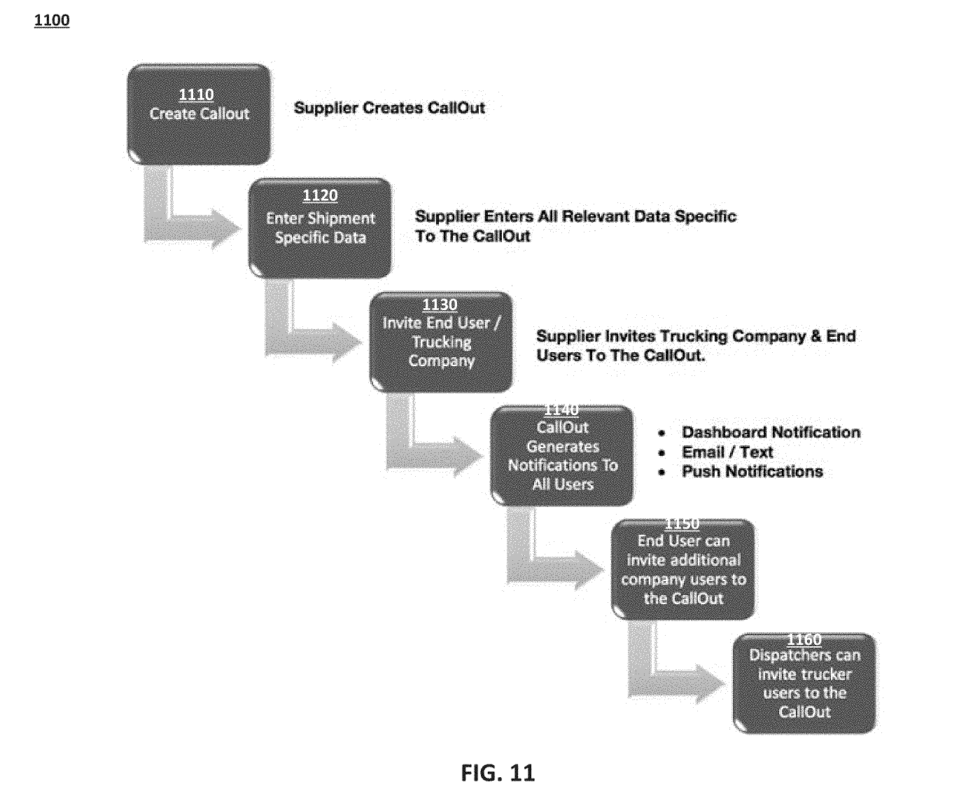

FIG. 11 illustrates a process 1100 for creating a callout by a supplier in accordance with the disclosed embodiments.

At a step 1110, a supplier may create a callout (e.g., after receiving a shipment order). In some embodiments, the supplier, using an associated user device, may transmit a request to create the callout to one or more servers 120A-120N. The request may include, for example, shipment data provided by the supplier, such as a type and an amount of goods to be delivered. The shipment data may be provided to the servers via an app operating on the user device (e.g., at a step 1120, at step 1110, or prior to creating the callout). Alternatively, or additionally, the shipment data may be provided to the servers via a website accessed via the user device.

After receiving the request, one or more servers 120A-120N may create the callout in one or more databases 130A-130N. In some embodiments, one or more servers 120A-120N may create a record of an active callout in one or more databases 130A-130N. The record may be created based on the shipment data included in the request.

At a step 1130, the servers 120A-120N may invite one or more end users to the callout. End users may include, for example, a customer of the supplier, a recipient of the shipment, and/or other stakeholders of the shipment. Additionally, the servers 120A-120N may invite one or more trucking companies to the callout. The trucking companies may be, for example, trucking companies that will be used by the supplier to deliver the shipment. The end-users and/or the trucking companies may be invited automatically by the servers 120A-120N based on the shipment data provided by the supplier. Alternatively, or additionally, the end-users and/or the trucking companies may be invited manually by the supplier via the supplier's user device.

At a step 1140, the servers 120A-120N may invite a user (e.g., end user or a trucking company) via an app operating on the user's device. For example, the server 120A-120N may invite an end user by displaying a notification that the end user was invited to a particular callout(s) on an app operating on the end user's mobile device. In another example, the server 120A-120N may invite a trucking company by displaying a notification that the trucking company was invited to a particular callout(s) on a website accessible by the trucking company. In some embodiments, the invitations may be provided via an email and/or a text message. In some embodiments, the invitations may be pushed to user devices (e.g., as a push notification on an iOS device).

After receiving an invitation, a user may accept or reject the invitation. If the invitation is accepted, the user is added to the callout. In some embodiments, the user may accept the invitation on an app operating on a user device, and the app may transmit an indication to the servers 120A-120N that the user has accepted the invitation. In response to receiving the indication, the servers 120A-120N may add the user to the callout (e.g., by adding/modifying a record in databases 130A-130N).

In some embodiments, the user that accepted the invitation may invite additional users to the callout. For example, at a step 1150, an end user that accepted the invitation may invite other stake holders (e.g., contractors at the delivery site) to the callout (e.g., at a step 1150). In another example, at a step 1160, a trucking company that accepted the invitation may invite truck drivers to the callout (e.g., at a step 1160).

The servers 120A-120N may facilitate real-time communications between users that are added to the same callout (see e.g., FIG. 5). For example, servers 120A-120N may facilitate real-time text-based communications between contractors awaiting the shipment and truck drivers.

The servers 120A-120N may also provide real-time shipment updates to users, for example, via a dashboard that can be displayed on user devices (see e.g., FIG. 5). The updates may include various status of one or more trucks, such as loads covered, whether a truck arrived at a storage yard (geofencing), whether a truck is loaded, whether a truck is resting, whether a truck is driving, whether a truck is experiencing delays, whether a truck is arrived at a destination, whether a truck is unloaded, and whether a truck completed a delivery.

In some embodiments, servers 120A-120N may notify at least some of the users associated with the callout regarding critical events. Critical event may include, for example, when loads are covered, when a truck arrived at a storage yard (geofencing), when a truck is loaded, when a truck begins resting, when a truck begins driving, when a truck is delayed, when a truck arrived at a destination, when a truck is unloaded, and when a truck completes the delivery.

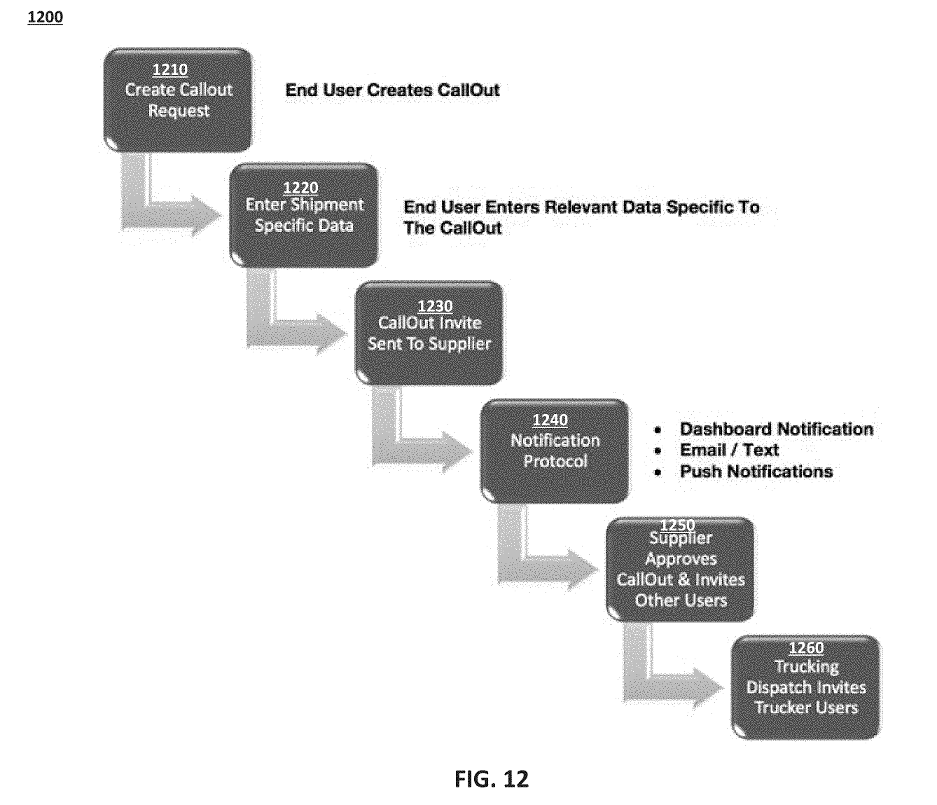

FIG. 12 illustrates a process 1200 for creating a callout by an end user in accordance with the disclosed embodiments.

At a step 1210, an end user may create a callout (e.g., after determining that a shipment of a particular material is needed). In some embodiments, the end user, using an associated user device, may transmit a request to create the callout to one or more servers 120A-120N. The request may include, for example, shipment data provided by the supplier, such as a type and an amount of needed goods. The shipment data may be provided to the servers via an app operating on the user device (e.g., at a step 1220, at step 1210, or prior to creating the callout). Alternatively, or additionally, the shipment data may be provided to the servers via a website accessed via the user device.

After receiving the request, one or more servers 120A-120N may create the callout in one or more databases 130A-130N. In some embodiments, one or more servers 120A-120N may create a record of an active callout in one or more databases 130A-130N. The record may be created based on the shipment data included in the request.

At a step 1230, the servers 120A-120N may invite one or more suppliers to the callout. The suppliers may be invited automatically by the servers 120A-120N based on the shipment data provided by the end user. Alternatively, or additionally, the suppliers may be invited manually by the end user via a user device.

At a step 1240, the servers 120A-120N may invite a user (e.g., a supplier) via an app operating on the user's device. For example, the server 120A-120N may invite a supplier by displaying a notification that the supplier was invited to a particular callout(s) on an app operating on the supplier's mobile device. In another example, the server 120A-120N may invite a supplier by displaying a notification that the supplier was invited to a particular callout(s) on a website accessible by the supplier's laptop. In some embodiments, the invitations may be provided via an email and/or a text message. In some embodiments, the invitations may be pushed to user devices (e.g., as a push notification on an iOS device).

After receiving an invitation, the supplier may accept or reject the invitation. If the invitation is accepted, the supplier is added to the callout. In some embodiments, the supplier may accept the invitation on an app operating on a user device, and the app may transmit an indication to the servers 120A-120N that the supplier has accepted the invitation. In response to receiving the indication, the servers 120A-120N may add the supplier to the callout (e.g., by adding/modifying a record in databases 130A-130N).

In some embodiments, users (e.g., suppliers) that accepted the invitation may invite additional users to the callout. For example, at a step 1250, a supplier that accepted the invitation may invite a truck dispatch to the callout. The truck dispatch, after accepting the invite, may add truck drivers to the callout (e.g., at a step 1260).

The servers 120A-120N may facilitate real-time communications among users that are added to the same callout (see e.g., FIG. 5). For example, servers 120A-120N may facilitate real-time text-based communications between contractors awaiting the shipment and truck drivers (e.g., to find out why a particular truck did not arrive on schedule).

The servers 120A-120N may also provide real-time shipment updates to users, for example, via a dashboard that can be displayed on user devices (see e.g., FIG. 5). The updates may include various status of one or more trucks, such as loads covered, whether a truck arrived at storage yard (geofencing), whether a truck is loaded, whether a truck is resting, whether a truck is driving, whether a truck is experiencing delays, whether a truck is arrived at a destination, whether a truck is unloaded, and whether a truck completed a delivery. In some embodiments, one or more adjustments to the callout may notify at least a subset of users of the callout that the adjustments have been made. In embodiments, the callout may be identified by an end user, a project name, a well name, and/or item delivered.

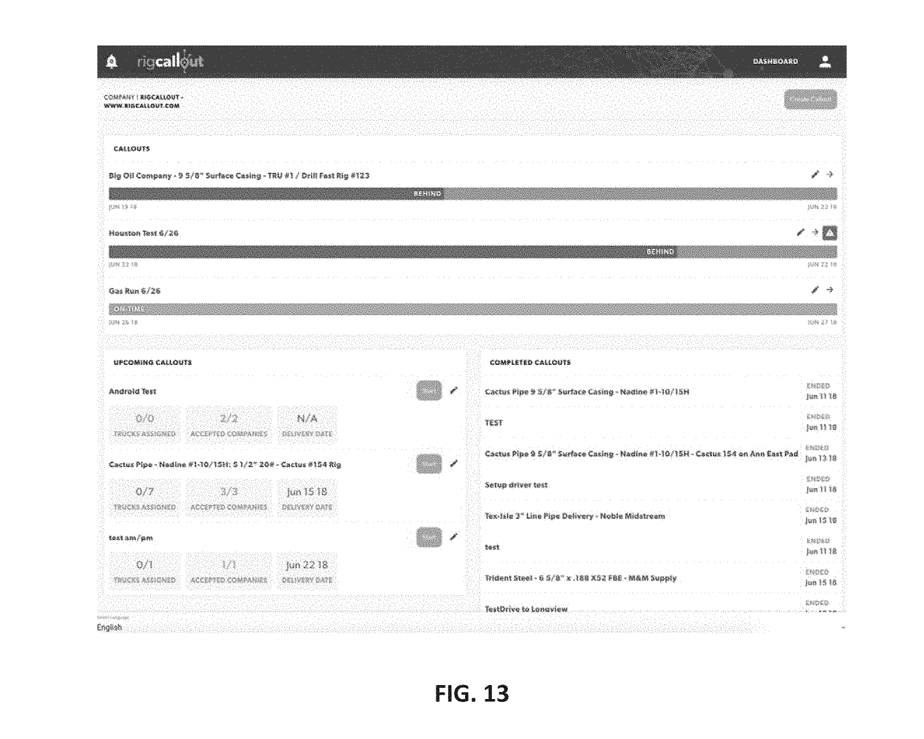

FIG. 13 illustrates a dashboard similar to the dashboard of FIG. 4 except that the dashboard of FIG. 13 does not include a message section. Further, the dashboard in FIG. 13 includes a “completed callouts” section listing callouts that have been recently completed.

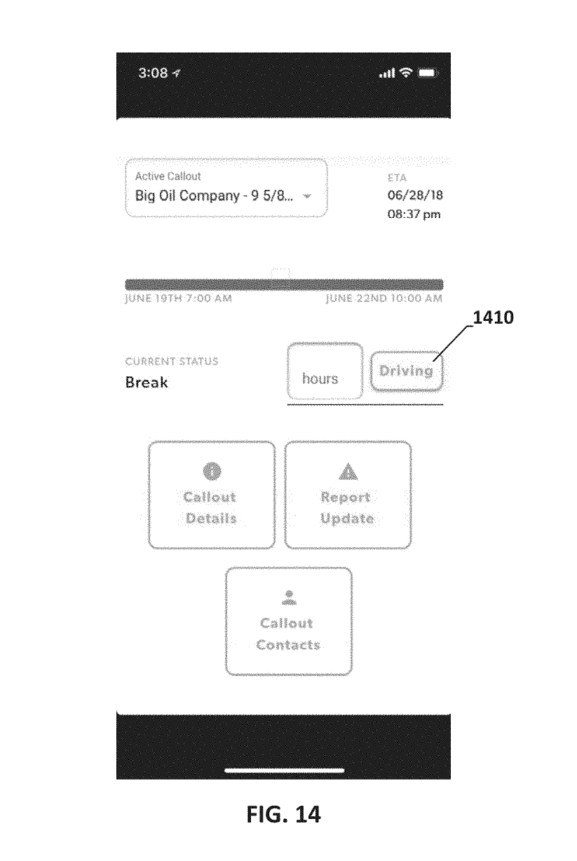

FIG. 14 illustrates a default Truck Driver Dashboard screen that is similar to the default screen shown in FIG. 10. Using the dashboard, a driver can view and change the status, for example, from “break” to “driving” by pressing button 1410. The status can be seen in dashboards of an end user, supplier, and/or truck dispatch, for example.

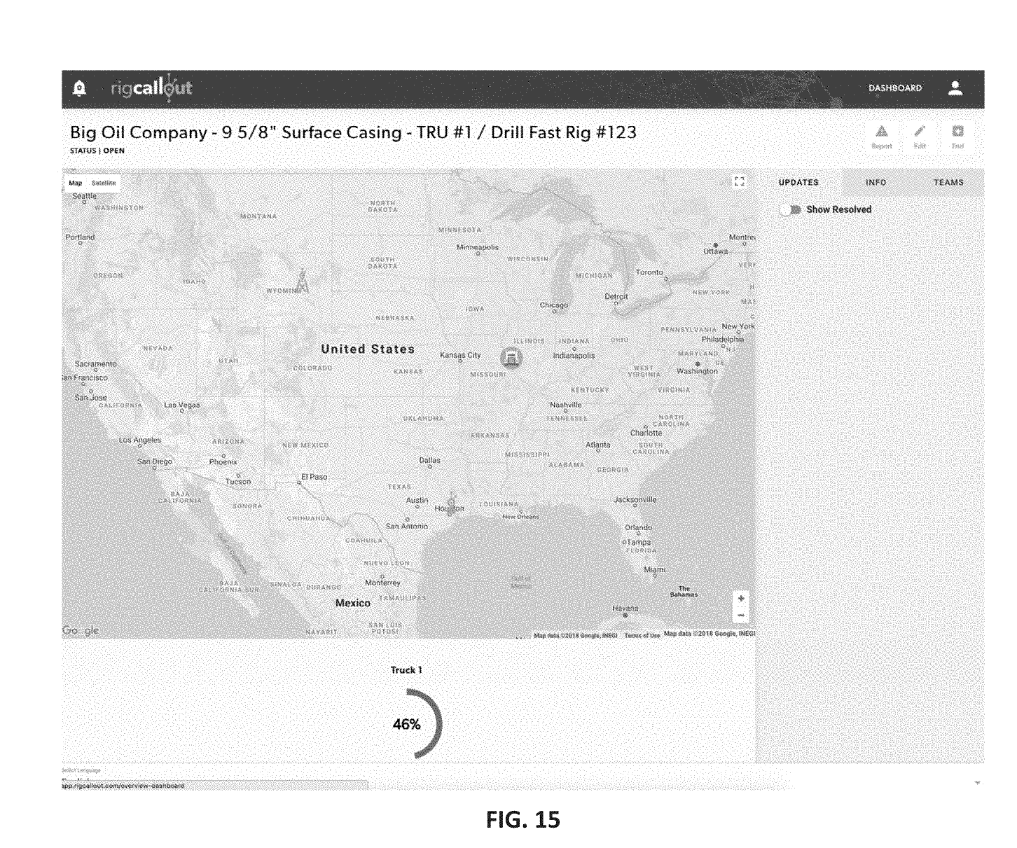

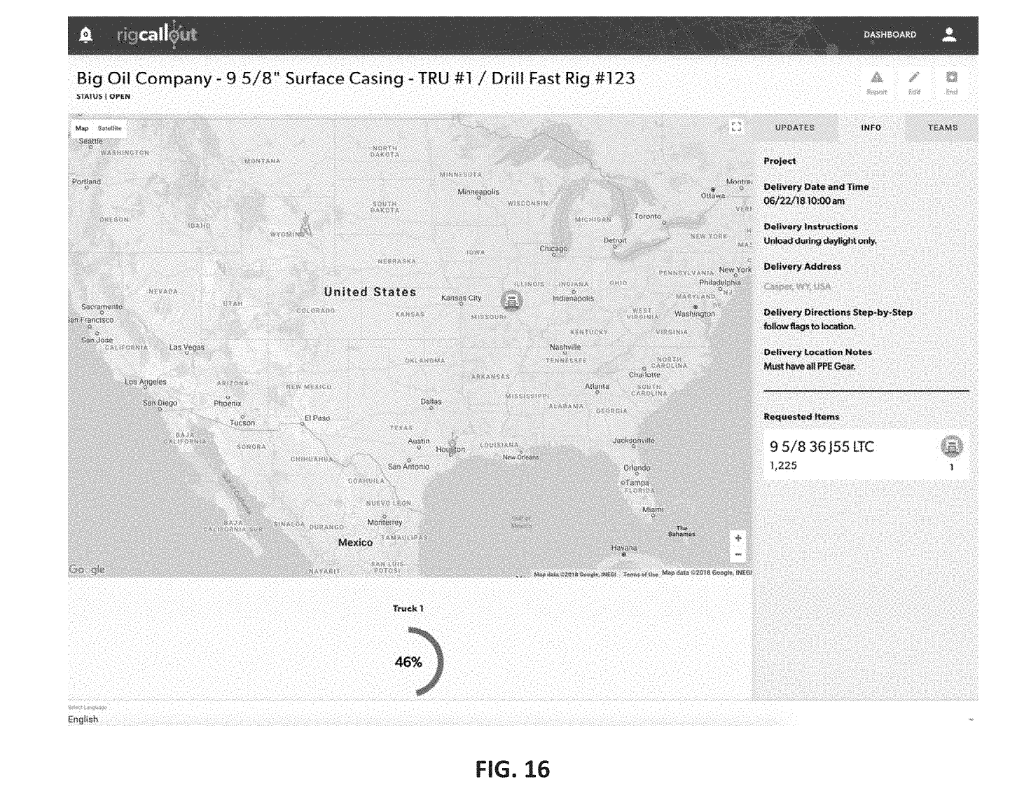

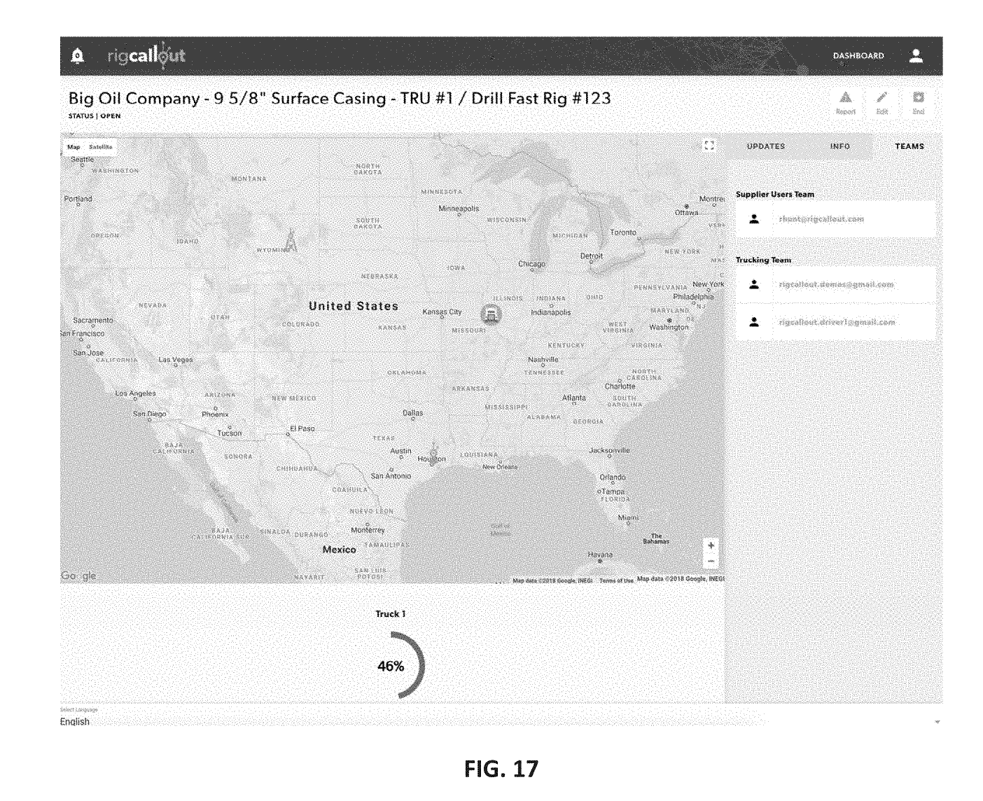

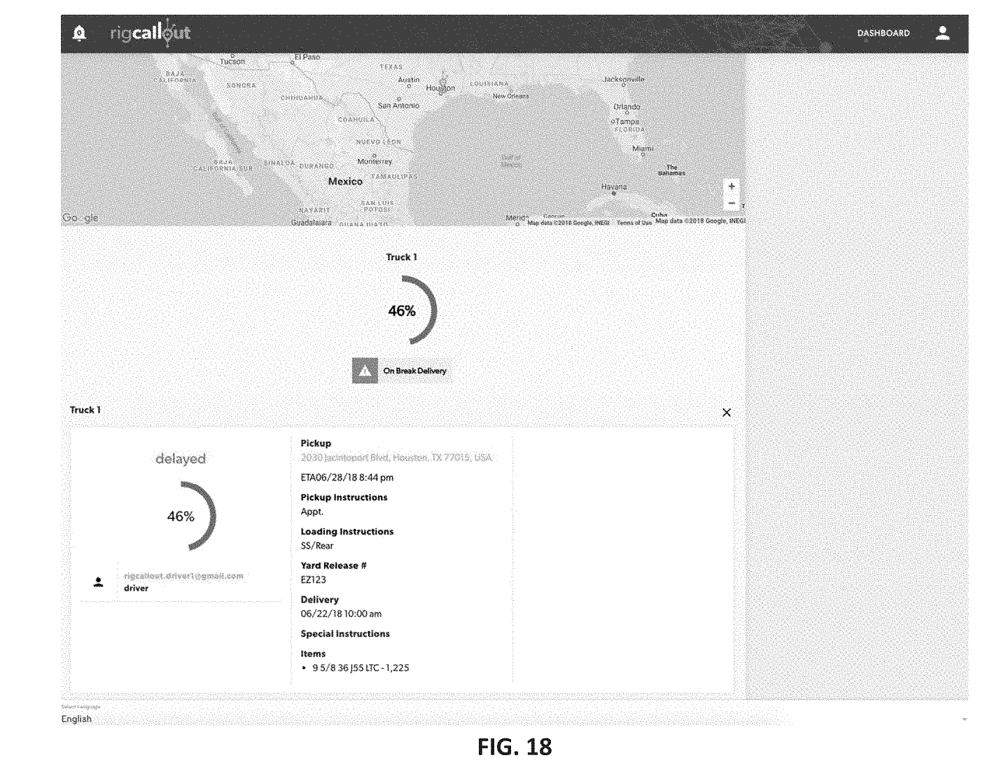

FIG. 15-18 illustrate various states of a default screen once a CallOut is selected in a menu bar similar to the default screen shown in FIG. 5. The default screen shows, for example, real-time truck locations, information regarding the requested delivery, and status of a truck involved in the delivery.

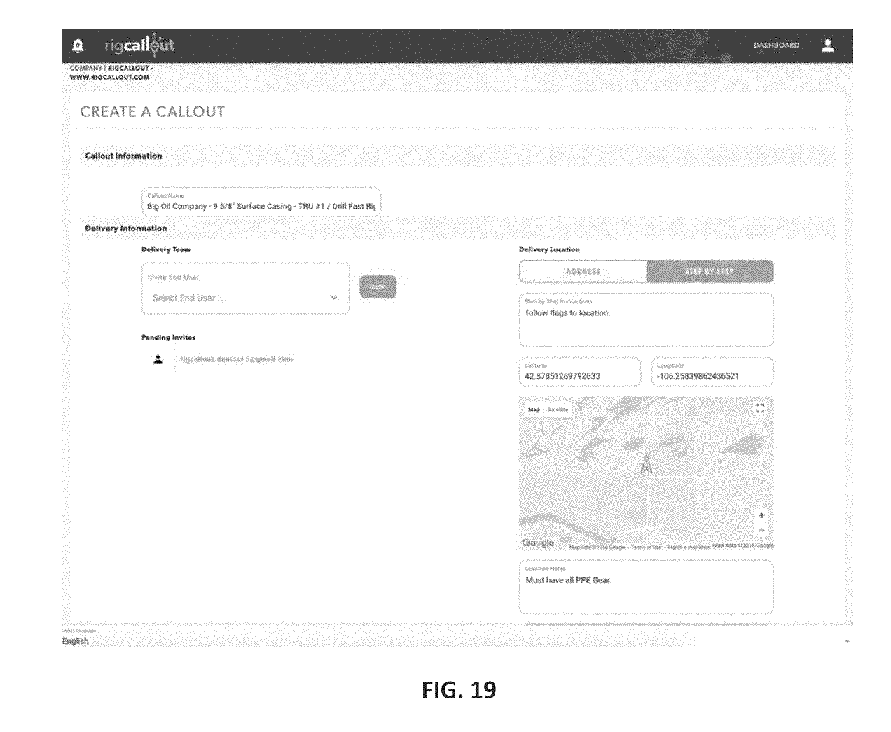

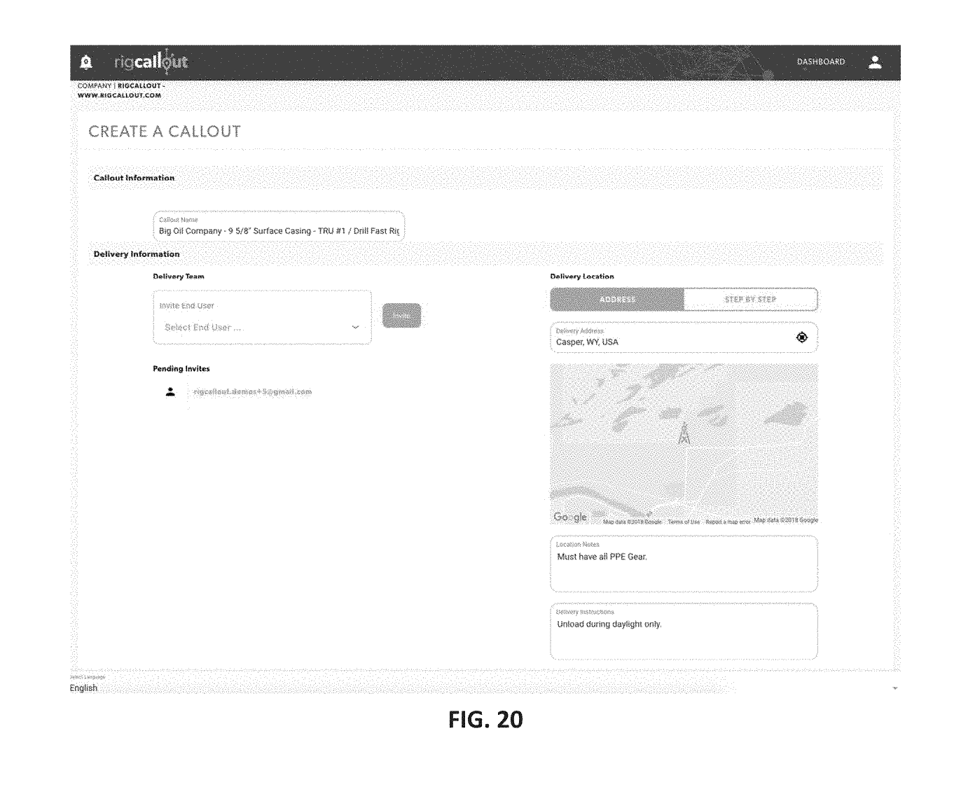

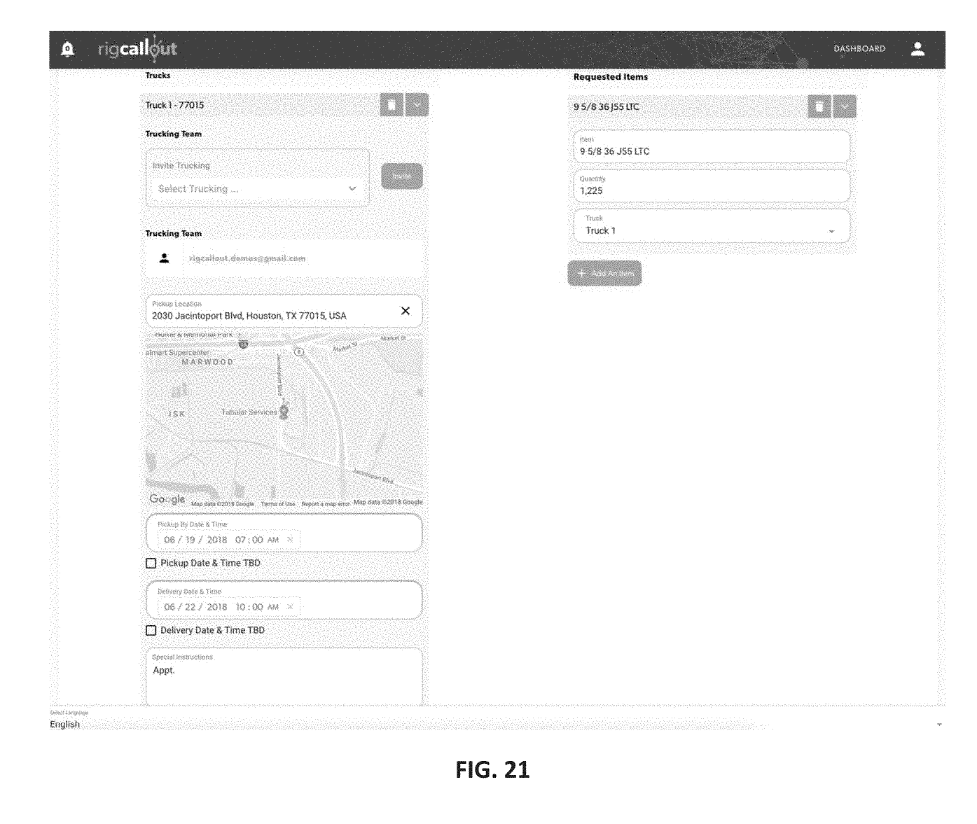

FIG. 19-21 illustrate various states of a default screen for creating of a callout similar to the screens shown in FIGS. 6 and 7.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A system for facilitating communications between users in a supply chain, the system comprising:
one or more servers communicatively connected via a network to one or more user devices; and
one or more databases communicatively connected to the servers, wherein:
the user devices are associated with at least an end user, a supplier, a trucking dispatch, and a driver associated with the trucking dispatch,
the servers are configured for:
receiving, from a user device of the end user, a request to create a shipment project, the request including shipment data received from the end user;
creating, in the databases, the project based on the request;
notifying a user device associated with the supplier that the supplier has been invited to the project;
receiving, from the user device associated with the supplier, an indication that the supplier approved the invitation;
after receiving the indication, adding the supplier to the project;
receiving requests to invite additional users to the project, wherein the additional users include at least the trucking dispatch and the driver;
notifying user devices associated with the additional users of their invitations;
facilitating real-time communications among users associated with the project; and
providing shipment updates associated with the project to at least one user device.

2. The system of claim 1, wherein the updates include whether a truck is experiencing a delay.

3. The system of claim 1, wherein the updates include real-time locations of a plurality of trucks.

4. The system of claim 1, wherein the real-time communications include voice-based communications.

5. The system of claim 1, wherein the additional users further include a storage yard.

6. A system for facilitating communications between users in a supply chain, the system comprising:
one or more servers communicatively connected via a network to one or more user devices; and
one or more databases communicatively connected to the servers, wherein:
the user devices are associated with at least an end user, a supplier, a trucking dispatch, and a driver associated with the trucking dispatch,
the servers are configured for:
receiving, from a user device of the supplier, a request to create a project, the request including shipment data received from the supplier;
creating, in the databases, the project based on the request;
notifying a user device associated with the end user that the end user has been invited to the project;
notifying a user device associated with the trucking dispatch that the trucking dispatch has been invited to the project;
receiving, from the user devices associated with the end user and the trucking dispatch, indications that the invitations have been approved;
adding the end user and the trucking dispatch to the project;
receiving requests to invite additional users to the project, wherein the additional users include at least the driver;
notifying user devices associated with the additional users of their invitations;
facilitating real-time communications among users associated with the project; and
providing shipment updates associated with the project to the users associated with the project.

7. The system of claim 6, wherein the updates include whether a truck is experiencing a delay.

8. The system of claim 6, wherein the updates include real-time locations of a plurality of trucks.

9. The system of claim 6, wherein the real-time communications include voice-based communications.

10. The system of claim 6, wherein the additional users further include a storage yard.

11. A method for facilitating communications between users in a supply chain, the method comprising:
receiving, from a user device of an end user, a request to create a shipment project, the request including shipment data received from the end user;
creating, in the databases, the project based on the request;
notifying a user device associated with a supplier that the supplier has been invited to the project;
receiving, from the user device associated with the supplier, an indication that the supplier approved the invitation;
after receiving the indication, adding the supplier to the project;
receiving requests to invite additional users to the project, wherein the additional users include at least a trucking dispatch and a driver;
notifying user devices associated with the additional users of their invitations;
facilitating real-time communications among users associated with the project; and
providing shipment updates associated with the project to at least one user device.

12. The method of claim 11, wherein the updates include whether a truck is experiencing a delay.

13. The method of claim 11, wherein the updates include real-time locations of a plurality of trucks.

14. The method of claim 11, wherein the real-time communications include voice-based communications.

15. The method of claim 11, wherein the additional users further include a storage yard.

16. A method for facilitating communications between users in a supply chain, the method comprising:
receiving, from a user device of a supplier, a request to create a project, the request including shipment data received from the supplier;
creating, in the databases, the project based on the request;
notifying a user device associated with an end user that the end user has been invited to the project;
notifying a user device associated with a trucking dispatch that the trucking dispatch has been invited to the project;
receiving, from the user devices associated with the end user and the trucking dispatch, indications that the invitations have been approved;
adding the end user and the trucking dispatch to the project;
receiving requests to invite additional users to the project, wherein the additional users include at least a driver;
notifying user devices associated with the additional users of their invitations;
facilitating real-time communications among users associated with the project; and
providing shipment updates associated with the project to the users associated with the project.

17. The method of claim 16, wherein the updates include whether a truck is experiencing a delay.

18. The method of claim 16, wherein the updates include real-time locations of a plurality of trucks.

19. The method of claim 16, wherein the real-time communications include voice-based communications.

20. The method of claim 16, wherein the additional users further include a storage yard.
